(19) United States
(12) Patent Application Publication
(10) Pub. No.: US 2025/0252399 A1
(43) Pub. Date: Aug. 7, 2025

(54) COMPUTER-IMPLEMENTED METHOD FOR CROSS-ACCOUNT MODEL DEPLOYMENT, COMPUTER PROGRAM ELEMENT AND COMPUTER READABLE MEDIUM

(71) Applicant: BASF AGRO TRADEMARKS GMBH, Ludwigshafen (DE)

(72) Inventors: Daniel LEVIN, Berlin (DE); Frederic HAASE, Köln (DE); Christian KERKHOFF, Köln (DE)

(21) Appl. No.: 18/855,154

(22) PCT Filed: Apr. 6, 2023
(86) PCT No.: PCT/EP2023/059103

§ 371 Date: Oct. 8, 2024

(30) Foreign Application Priority Data
Apr. 8, 2022 (EP) 22167444.3

(51) Int. Cl. G06Q 10/101; G06Q 50/02

(52) U.S. Cl. CPC G06Q 10/101; G06Q 50/02

(57) ABSTRACT

A computer-implemented method for cross-account model deployment is provided. According to the method, at least one artifact identifier of at least one to-be-deployed model artifact is provided. Further, at least one account tuple, the account tuple comprising a source account identifier identifying a source account and a target account identifier identifying a target account, is provided. Finally, the at least one to-be-deployed model artifact is moved from the source account to the target account. Further, a computer program element and a computer readable medium are provided.

### FIELD OF THE INVENTION

The present invention relates to a computer-implemented method for cross-account model deployment, moving at least one to-be-deployed model artifact from at least one source account to at least one target account. The present invention further relates to a corresponding computer program element and a corresponding computer readable medium.

### BACKGROUND OF THE INVENTION

In order to develop a machine learning model that can be put into production, in particular to serve customers, problems in two very different domains need to be solved: on one hand, the development and validation of the machine learning model requires solving problems in the domain of data science. On the other hand, the tasks of putting models into production at scale require solving problems in the software engineering and devops spaces. Often, these tasks are performed by two different teams which may use, for example, separate cloud computing accounts to maintain operational boundaries for security and reliability. And often, the transfer of the validated machine learning models from one team to the other team is done in an ad-hoc, manual fashion, with data and artifacts being exchanged between individuals and accounts, which makes the process slow, unreliable, non-repeatable and expensive. Similar problems are also present for the development and deployment of other software.

### SUMMARY OF THE INVENTION

It is therefore an object of the present invention to overcome the aforementioned problems. In particular, it is an object of the present invention to provide a well-defined process and software interface in order to automate the deployment of machine learning models that have been built and validated and put them into a production environment, in particular to serve customers. It is a further object of the present invention to provide a corresponding computer program element and a corresponding computer readable medium.

The object of the present invention is solved by the subject-matter of the independent claims, wherein further embodiments are incorporated in the dependent claims.

According to a first aspect of the invention, a computer-implemented method for cross-account model deployment is provided. In this context, “computer” may refer to any computing unit, in particular to a laptop computer, a desktop computer, a server, a supercomputer, and/or a network of any of the aforementioned computing units. Further, “cross-account” may refer to moving the model from one account to another account in the course of the model deployment. In this context, “account” is a computing account, is to be understood in a broad sense and may comprise an authorization as a specific registered user in accessing a system as well as resources pertaining to that user, in particular storage, in that system. In particular, account may refer to a single user account or a team account, particularly in a model development environment, wherein each single user or team may have at least one account. Also, an account may be an account, in particular in the model development environment, of an automatic model development tool. Further, “model” may refer to any type of software model, ranging from a simple application to a complex artificial intelligence model.

According to the method, at least one artifact identifier of at least one to-be-deployed model artifact is provided. Said artifact identifier may be, e.g., a file name of the to-be-deployed model artifact, a directory name of a directory where the at least one to-be-deployed model artifact is stored, or a name of the model, in particular along with a version number of the to-be-deployed model.

According to the method, also at least one account tuple is provided. Said account tuple is a 2-tuple, comprising a source account identifier and a target account identifier. The account identifiers are given, e.g., by a number or by a string, and are unique identifiers for an account, i.e., the source account identifier identifies the source account and the target account identifier identifies the target account.

According to the method, the at least one to-be-deployed model artifact is moved from the source account to the target account. In this context, “moving” is to be understood as copying, i.e., the model artifact will remain at the source account while it is also present at the target account after the move. Since the moving is performed by just providing the at least one artifact identifier and the at least one account tuple, it has several advantages. First, the computer-implemented method for cross-account model deployment is reliable, since there is very little input needed and hence there is only little space for mistakes to be made. Then, it is repeatable, since the input used for the method can be easily saved and hence the method can be repeated. Also, it is fast, since only little input has to be made and the remainder of the method is performed automatically. Finally, it is cost saving, since it is fast and since experts in the field of software engineering and devops spaces are no longer needed for the deployment of the model.

According to an embodiment, the model is a machine learning model. In particular, the model may be an artificial neural network, a deep neural network or a decision tree. These models benefit greatly from the method since usually, many moves between accounts are involved in the development of machine learning models until they reach a production account.

According to an embodiment, the model is an agricultural management model. In this context, “agricultural management model” may be any model that assists the cultivation of agricultural fields, horticultural fields and/or silvicultural fields. In particular, the agricultural management model may be a model for detecting types of pests, weather modeling, crop growth modeling, or the like. In particular, the agricultural management model may provide agronomic recommendations that may be used by a farmer to treat the fields, e.g., by providing optimal times for seeding and/or harvesting, or by providing amounts and types of agricultural products to the field. Here, agricultural products are to be understood in a broad sense and may comprise water, fertilizers and/or crop protection products such as fungicides, herbicides, insecticides, acaricides, molluscicides, nematicides, avicides, piscicides, rodenticides, repellants, bactericides, biocides, safeners, plant growth regulators, urease inhibitors, nitrification inhibitors and/or denitrification inhibitors. Said agricultural management models benefit from a fast deployment of the model that leads to a fast availability of new and/or improved features and/or data. Also, the agricultural management models benefit from the reliability of the model deployment, since this ensures that only correct models are used and hence no wrong decisions are made to treat the fields. Alternatively, or additionally, the agricultural management model provides agronomic control data. The agronomic control data is similar to the agronomic recommendation mentioned above, however, it is in a machine readable format such that it can be used to control a smart agricultural equipment such as a smart seeder or a smart sprayer.

According to an embodiment, the at least one to-be-deployed model artifact is at least one model file, sources file, script, binary executable file, database table, development deliverable, word-processing document and/or mail message. Here, the artifact, in particular the model file, may be organized in containers. Since the method may be applied to this variety of to-be-deployed model artifacts, it can be used extensively.

According to an embodiment, the method further comprises logging the at least one artifact identifier along with the at least one account tuple. In this context, “logging” may mean that the at least one artifact identifier along with the at least one account tuple is added to a log file and said log file is saved. Other alternatives for logging said data may also be used, such as adding the at least one account tuple to metadata of the at least one to-be-deployed model artifact associated with the at least one artifact identifier. Using the logged information, the deployment of the model artifact may be traced, i.e., one may track the accounts through which the model artifact has been moved, in particular, for monitoring and/or auditing purposes. Hence, the history of the model artifact is identifiable. Further information that may be logged together with the account tuples is the date and time of the deployment and the initiator of the deployment. Here, the initiator of the deployment may be identified by a user id or by a user account. Additionally, extra information about the model artifacts may be logged. Said extra information may be information on tests performed on the model artifact, such as the kind of test that has been performed, further details on the test, a date and time when the test has been performed and/or the user that has performed the test. This further improves the identification of the history of the model artifact.

According to an embodiment, a list of account tuples is provided, the list comprising at least two account tuples. Hence, the list encodes at least two moves of the at least one to-be-deployed model artifact. In particular, the list is an ordered list and the target account of one account tuple equals the source account of the next account tuple. Hence, the model is moved from one account to a next account and then from said next account to yet another account. More particularly, the account tuples in the list of account tuples are processed one after the other. Here, in particular, the next move may not start before the previous move is completed and, optionally, an action, such as testing, is successfully performed on the model.

According to an embodiment, at least one of the source accounts is a development account, i.e., an account in which the model is developed. Alternatively, or additionally, at least one of the accounts is a testing account, i.e., at least a source account or a target account or both a source account and a target account are a testing account. In this context, “testing” is to be understood in a broad sense and may refer, e.g., to testing of the model itself, to testing of the training of the model and/or to quality assurance. In particular, more than one testing account may be used. Alternatively, or additionally, at least one of the target accounts is a production account. The production account may be an account of an end user but may also be an account that services requests of an end user.

According to an embodiment, at least one of the accounts is a cloud-based account. In particular, at least one of the accounts may be provided by a cloud model development platform, more particularly by a cloud machine-learning platform.

According to an embodiment, the at least one artifact identifier and/or the at least one account tuple are provided by operator input. Said operator input may be made, e.g., via a command line or by executing a user-written input file. Alternatively, or additionally, the at least one artifact identifier and/or the at least one account tuple are provided by a user interface, in particular a representational state transfer application programming interface (REST API), and/or a graphical user interface. In the latter case, a user may, for example, draw a directed graph, connecting the accounts from and to which the model shall be moved.

According to an embodiment, the at least one artifact identifier and/or the at least one account tuple are provided automatically by a deployment script. Said deployment script may perform one, several or all of the steps from model development via model testing to production. In particular, the deployment script further performs automated model building. In this context, “automated model building” may comprise at least one out of automated model training, automated model validation and quality assurance testing. Since there is only little input needed for moving the model from a source account to a target account, the moving of the model across accounts may be smoothly integrated into the deployment script.

According to an embodiment, the method further comprises initializing the at least one account tuple. Said initialization of the account tuple may be performed upon being provided with the account tuple, i.e., as soon as the account tuple is provided to the method, the account tuple is initialized. In this case, once the initialization has been performed, the move from the source account to the target account may start as soon as it is requested. Alternatively, the initialization of the account tuple may be performed right before moving the at least one to-be-deployed model artifact from the source account to the target account, i.e., the initialization is performed on an on-demand basis. In this case, a recent initialization is provided for each move and, if some of the moves do not have to be performed, no superfluous initializations have been performed.

According to an embodiment, initializing the at least one account tuple comprises obtaining an authorization for the source account to share the at least one to-be-deployed model artifact and obtaining an authorization for the target account to receive the at least one to-be-deployed model artifact. Said authorizations may require access resources, e.g., user names, passwords and/or digital keys belonging to the accounts. These required access resources, e.g., user names, passwords and/or digital keys, may have been provided to the model in a set-up step. Moving the at least one to-be-deployed model artifact is then be performed from the source account to an intermediary and from the intermediary to the target account.

According to an embodiment, initializing the at least one account tuple comprises obtaining an authorization for the source account to access resources of the target account and/or obtaining an authorization for the target account to access resources of the source account. Again, the required access resources, e.g., user names, passwords and/or digital keys, may have been provided to the model in a set-up step. Moving the at least one to-be-deployed model artifact may then be performed by the source account by pushing the model artifact to the target account or by the target account by pulling the model artifact from the source account.

According to another aspect of the invention, a computer program element is provided. The computer program element is configured to carry out the method according to the above description when the computer program element is executed by a computing unit. Embodiments of the computer program element are evident from the embodiments of the method according to the above description.

According to another aspect of the invention, a computer readable medium is provided. The computer readable medium may be a hard disk, a data disk or a flash drive. The computer readable medium is configured to generate data to control the computing unit according to the method according to the above description. Embodiments of the computer readable medium are evident from the embodiments of the method according to the above description.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 shows an embodiment of a cross-account model deployment;

FIG. 2 shows another embodiment of a cross-account model deployment; and

FIG. 3 shows yet another embodiment of a cross-account model deployment.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF EMBODIMENTS

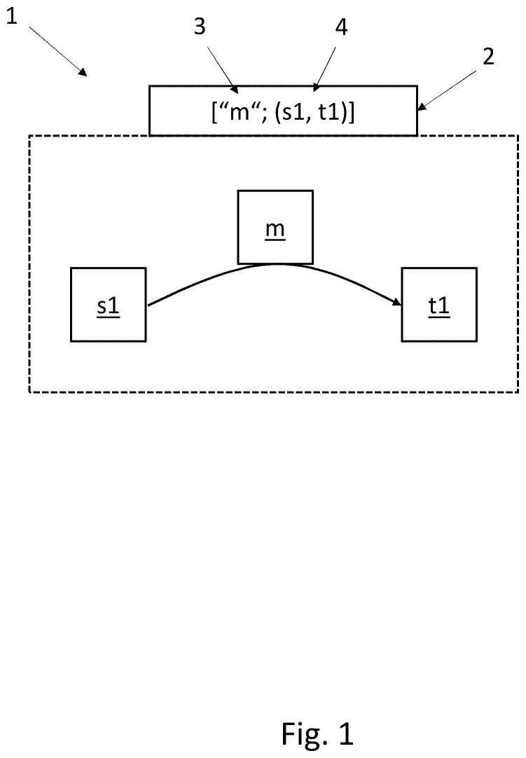

FIG. 1 shows an embodiment of a method 1 for cross-account model deployment. In this method 1, as an input 2, an artifact identifier 3 and an account tuple 4 are provided. The artifact identifier identifies a to-be-deployed model artifact m. The account tuple 4 comprises a source account identifier identifying a source account s1 and a target account identifier identifying a target account t1.

When the method 1 is executed, the to-be-deployed model artifact m is moved from the source account s1 to the target account t1. This move may be performed from the source account s1 to an intermediary (not shown here) and from the intermediary to the target account t1. Alternatively, the moving may be performed by the source account s1, pushing the model artifact m to the target account t1. Yet alternatively, the moving may be performed by the target account t1, pulling the model artifact m from the source account s1.

Since the input 2 needed by the method 1 is very simple, the method 1 is reliable, repeatable, fast and cost saving.

In order to identify the history of the model artifact m, the artifact identifier 3 may be logged along with the account tuple 4.

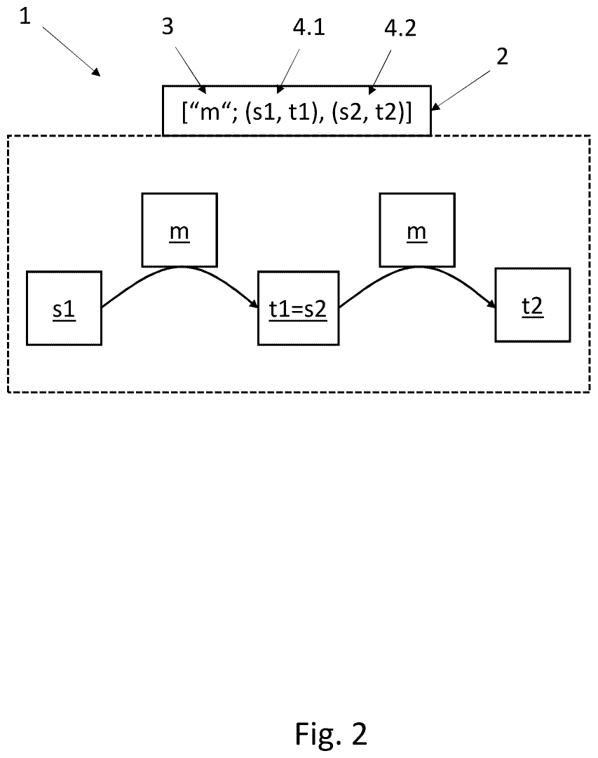

FIG. 2 shows another embodiment of a method 1 for cross-account model deployment. In this embodiment, three accounts s1, t1=s2 and t2 are shown, but in principle, any number of accounts is possible. In this embodiment, the target account t1 of a first account tuple 4.1 is coincident with the source account s2 of a second account tuple 4.2. The account tuples 4 may be processed one after the other, i.e., the move corresponding to the second account tuple 4.2 may only start after the move corresponding to the first account tuple 4.1 has been completed.

As an example, the first source account s1 may be a development account, the first target account t1 which is at the same time the second source account s2 may be a testing account and the second target account t2 may be a production account. Naturally, there may be a larger number of accounts, in particular more intermediate testing accounts.

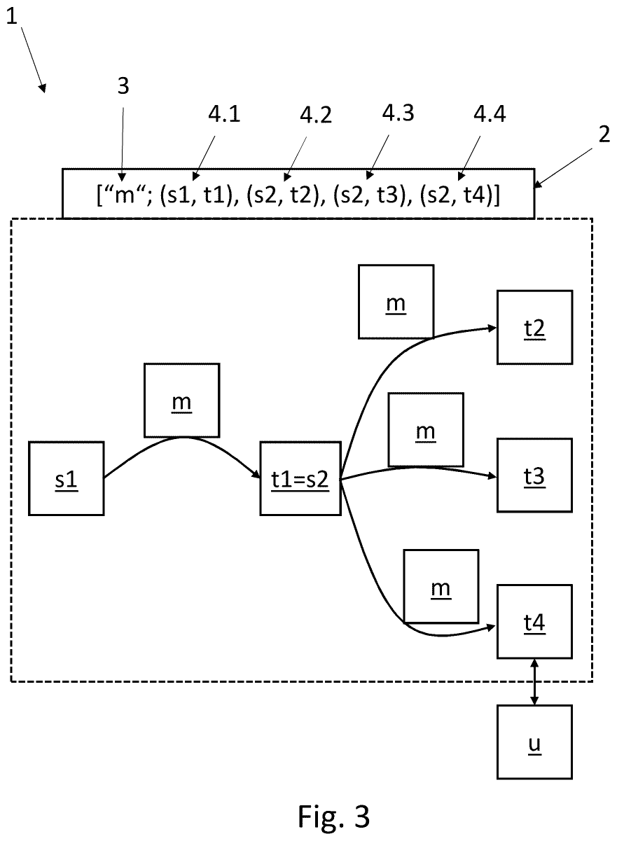

FIG. 3 shows yet another embodiment of a method 1 for cross-account model deployment. In this embodiment, a third account tuple 4.3 and a fourth account tuple 4.4 lead to moving the model artifact m to two additional production accounts t3 and t4.

Also shown in FIG. 3 is an exemplary interaction of a user u with the production account t4. As an example, said user u may be a farmer, providing pictures of diseases or pests to the model m at the production account t4 and receiving, in response to the sent pictures, agronomic recommendations and/or agronomic control data from the model m at the production account t4.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A computer-implemented method for cross-account model deployment, comprising:
providing at least one artifact identifier of at least one to-be-deployed model artifact;
providing at least one account tuple, the account tuple comprising a source account identifier identifying a source account and a target account identifier identifying a target account; and
moving, the at least one to-be-deployed model artifact from the source account to the target account.

2. The method according to claim 1, wherein the model is a machine learning model.

3. The method according to claim 1, wherein the model is an agricultural management model.

4. The method according to claim 1, wherein the at least one to-be-deployed model artifact is at least one out of model files, sources files, scripts, binary executable files, database tables, development deliverables, word-processing documents and/or mail messages.

5. The method according to claim 1, further comprising: logging the at least one artifact identifier along with the at least one account tuple.

6. The method according to claim 1, wherein a list of account tuples is provided, the list comprising at least two account tuples.

7. The method according to claim 1, wherein at least one of the source accounts is a development account, at least one of the accounts is a testing account and/or at least one of the target accounts is a production account.

8. The method according to claim 1, wherein at least one of the accounts is a cloud-based account.

9. The method according to claim 1, wherein the at least one artifact identifier and/or the at least one account tuple are provided by operator input and/or by a user interface.

10. The method according to claim 1, wherein the at least one artifact identifier and/or the at least one account tuple are provided automatically by a deployment script and, optionally, the deployment script further performs automated model training, automated model validation and/or quality assurance testing.

11. The method according to claim 1, wherein the method further comprises initializing the at least one account tuple, and the initialization of the account tuple is, optionally, performed upon being provided with the account tuple or right before moving the at least one to-be-deployed model artifact.

12. The method according to claim 1, wherein initializing the at least one account tuple comprises:
obtaining an authorization for the source account to share the at least one to-be-deployed model artifact; and
obtaining an authorization for the target account to receive the at least one to-be-deployed model artifact,
wherein moving the at least one to-be-deployed model artifact is performed from the source account to an intermediary and from the intermediary to the target account, and, optionally,
wherein access resources required to obtain the authorizations are provided in a set-up step.

13. The method according to claim 1,
wherein initializing the at least one account tuple comprises obtaining an authorization for the source account to access resources of the target account and moving the at least one to-be-deployed model artifact is performed by the source account by pushing the model artifact to the target account; and/or
wherein initializing the at least one account tuple comprises obtaining an authorization for the target account to access resources of the source account and moving the at least one to-be-deployed model artifact is performed by the target account by pulling the model artifact from the source account; and, optionally,
wherein access resources required to obtain the authorizations are provided in a set-up step.

14. A computer program element which when executed by a computing unit is configured to carry out the method according to claim 1.

15. A computer readable medium that generates data to control a computing unit according to the method according to claim 1.

16. The method according to claim 1, wherein the moving comprises copying.

17. The method according to claim 3, wherein the agricultural management model provides agronomic recommendations and/or agronomic control data.

18. The method according to claim 6, wherein the target account of one account tuple equals the source account of the next account tuple in the list.

19. The method according to claim 6, wherein the account tuples in the list of account tuples are processed one after the other.

20. The method according claim 9, wherein the user interface is a representational state transfer application programming interface, REST API, and/or a graphical user interface.
